(19) United States
(12) Patent Application Publication
(10) Pub. No.: US 2013/0145276 A1
(43) Pub. Date: Jun. 6, 2013

(54) METHODS AND APPARATUS FOR ENABLING CONTEXT-AWARE AND PERSONALIZED WEB CONTENT BROWSING EXPERIENCE

(71) Applicants: Sailesh Kumar Sathish, Tampere (FI); Jari Hämäläinen, Kangasala As (FI); Tian Jilei, Beijing (CN)

(72) Inventors: Sailesh Kumar Sathish, Tampere (FI); Jari Hämäläinen, Kangasala As (FI); Tian Jilei, Beijing (CN)

(73) Assignee: Nokia Corporation, Espoo (FI)

(21) Appl. No.: 13/308,840

(22) Filed: Dec. 1, 2011

(51) Int. Cl. G06F 3/01; G06F 11/30; G06F 15/16

(52) U.S. Cl. 715/738

(57) ABSTRACT

An apparatus comprising at least one processor and at least one memory including computer program code, the at least one memory, computer program code, and processor configured to cause the apparatus to receive a content package comprising one or more selectable segments and at least one dynamic content segment. The apparatus may be configured to parse the content package for topics and provide for one or more user preference models. The apparatus may be configured to match the parsed topics with predefined topics from a user preference model. The apparatus may be configured to monitor user interactions with the selectable segments and provide an external script with a list of prioritized and/or matched topics. The apparatus may provide at least one dynamic content segment as directed by a script, wherein the dynamic content segment may change based upon a user interaction. Corresponding methods and computer program products are also provided.

### TECHNOLOGICAL FIELD

An example embodiment of the present invention relates generally to techniques for monitoring user context and interactions with web content browsing, and more particularly, relates to an apparatus, a method and a computer program product for providing a context-aware and personalized web browsing experience to a user based at least in part on a user's context, interactions and/or a user preference model.

### BACKGROUND

In order to provide easier or faster information transfer and convenience, telecommunication industry service providers are continually developing improvements to existing communication networks. As a result, wireless communication has become increasingly more reliable in recent years. Along with the expansion and improvement of wireless communication networks, mobile terminals used for wireless communication have also been continually improving. In this regard, due at least in part to reductions in size and cost, along with improvements in battery life and computing capacity, mobile terminals have become more capable, easier to use, and cheaper to obtain. Due to the now ubiquitous nature of mobile terminals, people of all ages and education levels are utilizing mobile terminals to communicate with other individuals or contacts, receive services and/or share information, media and other content.

User interactions with content packages, such as those provided by browsing applications, have been limited. User experiences with these content packages may be improved by methods which may provide altering the content packages or providing additional content. Some of the technologies which are becoming more popular are those of location based services and other personalized services. In this regard, some technologies may provide users of properly equipped mobile terminals with content which is specific to the present location of the user, present activity of the user, or other contextual information. Further, in other instances, a user may be provided with information such as Uniform Resource Locators (URLs) which relate to one or both of the user's interests and the user's present location along with other contextual characteristics. Thereby, content may be provided to the user automatically which may be relevant to the user's interest and current context. This content may in some cases be displayed on the home screen of the mobile terminal.

### BRIEF SUMMARY

A method, apparatus and computer program product therefore provide for monitoring user interactions with selectable segments of a content package, and determining contextual characteristics related thereto.

In an example embodiment, an apparatus comprises at least one processor and at least one memory including computer program code, the at least one memory and the computer program code configured to, with the processor, cause the apparatus to receive a content package from a content provider, such as a browser application, comprising one or more selectable segments and at least one dynamic content segment. In addition, the apparatus may provide for one or more user preference models and may monitor one or more user interactions with at least one of the selectable segments. Further, the apparatus may be configured to provide the at least one dynamic content segment as directed by the script, wherein the dynamic content segment corresponds to at least one user preference model.

In an additional example embodiment a method comprises receiving a content package comprising one or more selectable segments and at least one dynamic content segment. Further, the method may include providing for one or more user preference models. In another embodiment, the method may comprise monitoring one or more user interactions with at least one of the selectable segments via a processor. Further still, the method may include providing the at least one dynamic content segment as directed by the script, wherein the dynamic content segment corresponds to at least one user preference model.

In a further example embodiment, a computer program product comprising at least one non-transitory computer-readable storage medium having computer-readable program instructions stored therein, the computer-readable program instructions comprising program instructions configured to cause an apparatus to perform a method comprising receiving a content package comprising one or more selectable segments and at least one dynamic content segment. Further, the computer program product may include instructions configured to cause an apparatus to perform a method including providing for one or more user preference models. In addition, the computer program product may include program code instructions for monitoring one or more user interactions with at least one of the selectable segments, and providing the at least one dynamic content segment as directed by the script, wherein the dynamic content segment corresponds to at least one user preference model.

In yet another example embodiment, an apparatus is provided that includes means for receiving a content package comprising one or more selectable segments and at least one dynamic content segment. Further, the apparatus may include means for providing for one or more user preference models. In another embodiment, the apparatus may comprise means for monitoring one or more user interactions with at least one of the selectable segments. Further still, the apparatus may include means for providing the at least one dynamic content segment as directed by the script.

### BRIEF DESCRIPTION OF THE SEVERAL VIEWS OF THE DRAWINGS

Having thus described example embodiments of the present disclosure in general terms, reference will now be made to the accompanying drawings, which are not necessarily drawn to scale, and wherein:

FIG. 1 illustrates a schematic block diagram of a system according to an example embodiment of the present invention;

FIG. 2 illustrates a schematic block diagram of an apparatus configured to provide a dynamic content segment according to an example embodiment of the present invention;

FIG. 3 illustrates a flowchart of the operations performed in providing a dynamic content segment according to an example embodiment of the present invention;

FIG. 4 illustrates a user interface according to one example embodiment of the present invention;

FIG. 5 illustrates a user interface according to another example embodiment of the present invention; and

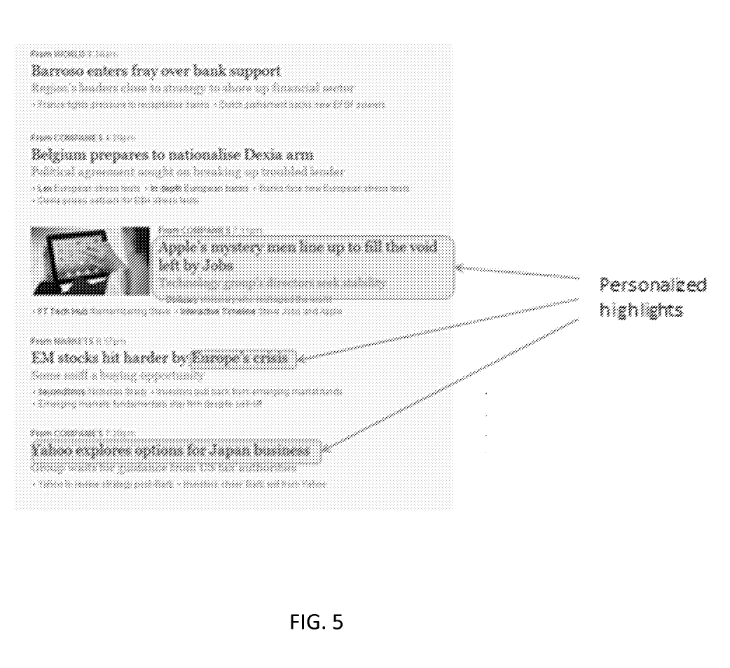

FIG. 6 illustrates a user interface according to yet another example embodiment of the present invention.

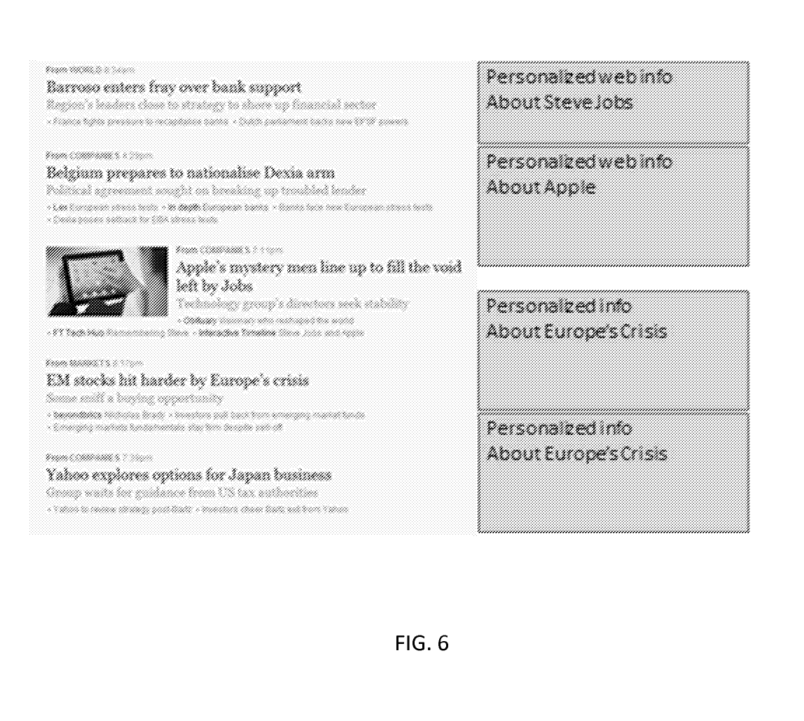

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout.

As used herein, the terms “data,” “content,” “information” and similar terms may be used interchangeably to refer to data capable of being transmitted, received and/or stored in accordance with embodiments of the present invention. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

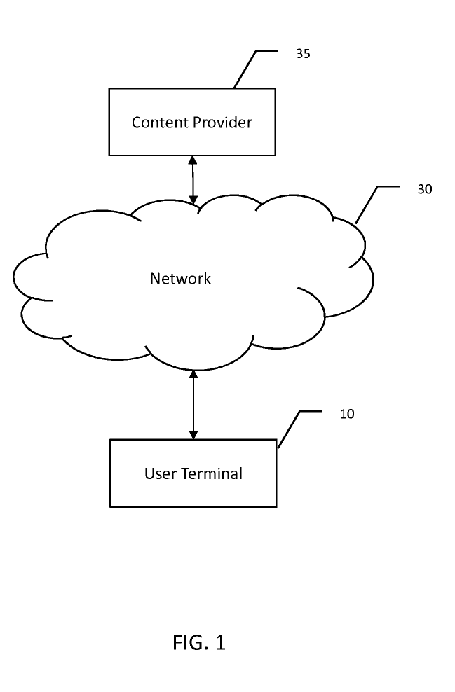

As indicated above, some embodiments of the present invention may be employed in methods, apparatuses and computer program products configured to provide dynamic content segments based at least in part on a user preference model and/or user interactions with a content package. In this regard, for example, FIG. 1 illustrates a block diagram of a system that may benefit from embodiments of the present invention. It should be understood, however, that the system as illustrated and hereinafter described is merely illustrative of one system that may benefit from an example embodiment of the present invention and, therefore, should not be taken to limit the scope of embodiments of the present invention.

As shown in FIG. 1, a system in accordance with an example embodiment of the present invention may include a user terminal 10. The user terminal 10 may be any of multiple types of fixed or mobile communication and/or computing devices such as, for example, personal digital assistants (PDAs), pagers, mobile televisions, mobile telephones, gaming devices, laptop computers, personal computers (PCs), cameras, camera phones, video recorders, audio/video players, radios, global positioning system (GPS) devices, or any combination of the aforementioned, which employ an embodiment of the present invention.

In some embodiments the user terminal 10 may be capable of communicating with other devices, either directly, or via a network 30. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network 30 may be a cellular network, a mobile network and/or a data network, such as a local area network (LAN), a metropolitan area network (MAN), and/or a wide area network (WAN), for example, the Internet. In turn, other devices such as processing elements (for example, personal computers, server computers or the like) may be included in or coupled to the network 30. By directly or indirectly connecting the user terminal 10 and the other devices to the network 30, the user terminal and/or the other devices may be enabled to communicate with each other, for example, according to numerous communication protocols including Hypertext Transfer Protocol (HTTP) and/or the like, to thereby carry out various communication or other functions of the user terminal and the other devices, respectively. As such, the user terminal 10 and the other devices may be enabled to communicate with the network 30 and/or each other by any of numerous different access mechanisms. For example, mobile access mechanisms such as universal mobile telecommunications system (UMTS), wideband code division multiple access (W-CDMA), CDMA2000, time division-synchronous CDMA (TD-CDMA), global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network 30 may be a home network or other network providing local connectivity.

The user terminal 10 may be configured to output uniform resource locator (URL) links and/or other types of content such as pictures, data, maps, audio, or video for selection by the user. Thus, the system may additionally comprise one or more content providers 35 which provide the content to the user terminal 10. In some embodiments each of the content providers 35 may be embodied as a server, server bank or other computer or other computing device or node configured to provide content to the user terminal 10. Each content provider 35 may have any number of functions or associations with various services. As such, for example, each of the content providers 35 may be a platform such as a dedicated server (or server bank), or each of the content providers may be a backend server associated with one or more other functions or services. Thus, the content providers may provide various types and forms of content to the user terminal 10.

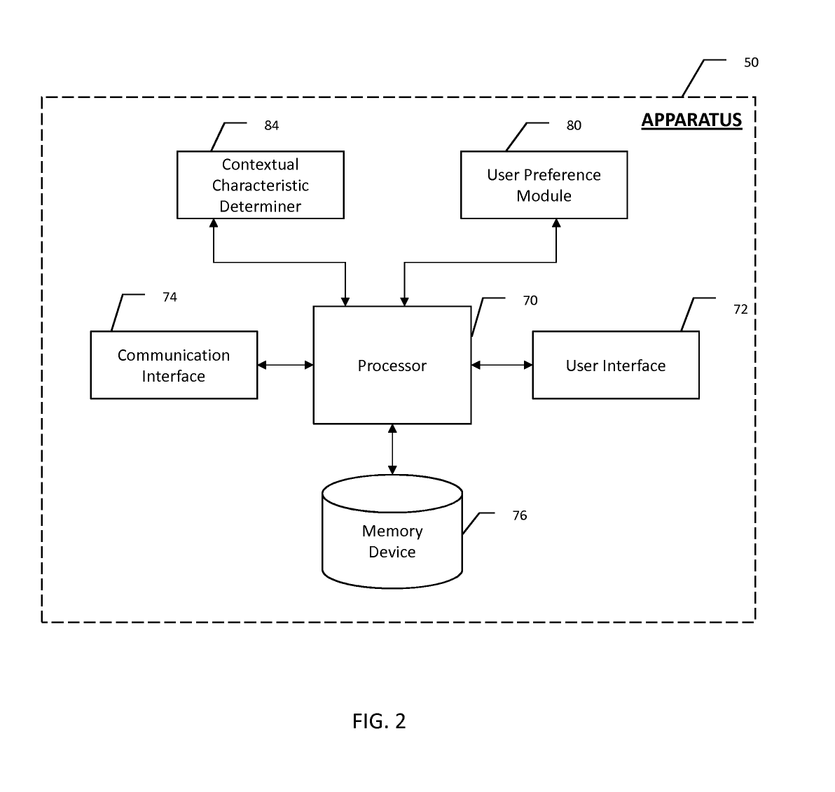

In an example embodiment, an apparatus 50 is provided that may be employed by devices performing example embodiments of the present invention. The apparatus 50 may be embodied, for example, as any device hosting, including, controlling, comprising, or otherwise forming a portion of the user terminal 10 and/or the content providers 35. However, embodiments may also be embodied on a plurality of other devices such as for example where instances of the apparatus 50 may be embodied by a network entity. As such, the apparatus 50 of FIG. 2 is merely an example and may include more, or in some cases less, than the components shown in FIG. 2.

With further regard to FIG. 2, the apparatus 50 may be configured to provide at least one dynamic content segment as directed by a script, the dynamic content segment corresponding to at least one of a user preference model, user interaction, contextual characteristics and/or the like. The apparatus 50 may include or otherwise be in communication with a processor 70, a user interface 72, a communication interface 74 and a memory device 76. The memory device 76 may be configured to store information, data, files, applications, instructions and/or the like. For example, the memory device 76 could be configured to buffer input data for processing by the processor 70. Alternatively or additionally, the memory device 76 could be configured to store instructions for execution by the processor 70.

As mentioned above, in some embodiments, the apparatus 50 may be embodied by a user terminal or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 70 may be embodied in a number of different ways. For example, the processor 70 may be embodied as one or more of various hardware processing means such as a co-processor, a microprocessor, a controller, a digital signal processor (DSP), a processing element with or without an accompanying DSP, or various other processing devices including integrated circuits such as, for example, an ASIC (application specific integrated circuit), an FPGA (field programmable gate array), a hardware accelerator, a special-purpose computer chip, or other hardware processor. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor. The processor 70 may also be further configured to execute hard coded functionality. As such, whether configured by hardware or software methods, or by a combination thereof, the processor 70 may represent an entity (for example, physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor to perform the algorithms and/or operations described herein when the instructions are executed. However, in some cases, the processor 70 may be a processor of a specific device (for example, a user terminal, a network device such as a server, a mobile terminal, or other computing device) adapted for employing embodiments of the present invention by further configuration of the processor by instructions for performing the algorithms and/or operations described herein. The processor 70 may include, among other things, a clock, an arithmetic logic unit (ALU) and logic gates configured to support operation of the processor.

Meanwhile, the communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (for example, network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 74 may include hardware and/or software for supporting communication mechanisms such as BLUETOOTH®, Infrared, UWB, WiFi, and/or the like, which are being increasingly employed in connection with providing home connectivity solutions.

In some embodiments the apparatus 50 may further be configured to receive a content package comprising one or more selectable content segments. In one embodiment, the communication interface 74 may be configured to receive a content package comprising a plurality of data. In this regard, the processor 70, in conjunction with the communication interface 74, may be configured to receive a content package relating to a URL, which may include one or more selectable segments therein, the selectable segments corresponding to additional URLs. In other embodiments, the selectable segments may include written text, pictures, or other data corresponding to the content. Accordingly, the processor 70 may cause the content package to be displayed upon a user interface 72, such as a display and/or a touchscreen display.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, a microphone, a speaker, or other input/output mechanisms. Alternatively or additionally, the processor 70 may comprise user interface circuitry configured to control at least some functions of one or more elements of the user interface 72, such as, for example, the speaker, the ringer, the microphone, the display, and/or the like. The processor 70 and/or user interface circuitry comprising the processor 70 may be configured to control one or more functions of one or more elements of the user interface 72 through computer program instructions (e.g., software and/or firmware) stored on a memory accessible to the processor 70 (e.g., memory device 76, and/or the like).

In another embodiment, the user interface 72 may be configured to record and/or track an eye movement of the user. Accordingly, the apparatus 50, such as the processor 70 and/or the user interface 72, may be configured to determine a specific content segment of the content package a user is viewing by monitoring the eye movements of the user. In one embodiment, the user interface 72 may comprise a camera or other image data recording device configured to record and/or track the eye movement of the user. Additionally or alternatively, the user interface 72 and/or the processor 70 may be configured to determine the location of the user focus, such as the location of a mouse pointer or other cursor on a display providing the content package. Further, the user interface 72 may be configured to communicate with a memory device 76 so as to store data relating to a user's interaction with the content package, user interface, and/or the like.

In another embodiment, the content package may further comprise a script configured to provide at least one dynamic content segment. In this regard, the apparatus 50 may include a memory device 76 comprising data corresponding to a pre-defined user preference model. Accordingly, the user preference model may include data corresponding to a user's particular interests, preferences, and other unique preferences. The user preference model may be predefined or the user preference model may be constructed by the apparatus 50, such as the processor 70, based on the user interaction with the user terminal. In either instance, the user preference model may be supplemented by the apparatus 50, such as the processor 70, based upon the more recent interaction that the user has with the user terminal. Additionally, the user preference model may include data corresponding to the duration of time a user views a particular content package, such as a web page, or a segment of the content package, such as a particular portion of a web page presented in a web browser. Accordingly, each user may have a different user preference model that is unique to the user's individual experience and habits when accessing various content packages.

In some embodiments, the apparatus 50 may further include a user preference module 80 configured to monitor a user interaction with selectable segments of the content package. The processor 70 or other circuitry may be embodied as, include or otherwise control the user preference module 80. Additionally or alternatively, the user preference module 80 may be configured to determine topics and/or attributes related to each of the selectable segments of the content package. In one example embodiment, the user preference module 80 may be configured to parse a content package, such as a web page relating to a URL. In addition, the apparatus 50 may be configured to build a set of topics contained within the content package based at least in part on the user preference module 80 parsing the content package. In another embodiment, the apparatus 50 may include a user preference module 80 configured to record the duration of time a user interacts with a particular content package. Further, the user preference module 80 may be configured, in conjunction with the processor 70, to store data related to a user's interaction with the memory device 76. Alternatively or additionally, the apparatus 50, such as the processor 70, may be configured to receive a content package including particular topics, determine the particular topics located within the content package via a user preference module 80, and further may be configured to process the topics located within the content package so as to prioritize which topics match the pre-defined user preference model, which may be stored within the memory device 76. The storage location for the data corresponding to the user preference model may vary in some embodiments. In this regard, in some embodiments the apparatus 50 may provide for storage of the data locally in the memory device 76. In other embodiments the apparatus 50 may provide for storage of the data in a remote location. For example, the communication interface 74 may provide for transmission of the user interactions, the contextual characteristics, the selectable segments, and/or other information contained in data, and thus the data may be stored and/or processed externally from the apparatus 50 in some embodiments.

In one embodiment, the apparatus 50, such as the processor 70, may be configured to match the topics within the content package to a pre-defined user preference model such that the topics within the content package are prioritized based at least in part on the user preference model. In this regard, the user preference model may include data indicating a particular topic located within the content package is of greater interest than another topic located within the content package. In another embodiment, the user preference module 80 may be configured to process the topics located within the content package, and may be further configured to present the topics in an order corresponding to the prioritization based at least in part on the user preference model. Alternatively, the user preference module 80 may be configured to process the topics, but may present the topics in an order that does not correspond to the prioritization based at least in part on the user preference model. The user preference module 80 may be configured to gather the topics presented within the content package that will be of interest to the user, those topics being presented within the received content package. Accordingly, the apparatus 50, such as the processor 70, may be configured to provide to a content provider, such as an external script or external browser application, data corresponding to a particular user's preference. In one embodiment, the apparatus 50, such as the processor 70, may be configured to provide an external script or external browser application with data corresponding to topics presented within the content package, and more particularly, the individual user's preference for each particular topic located within the content package. As such, execution of the script by the processor 70 may provide additional dynamic content segments within the content package corresponding to the topics and/or selectable segments presented within the content package.

In some embodiments, the apparatus 50 may further include a contextual characteristic determiner 84. The processor 70 or other circuitry may be embodied as, include or otherwise control the contextual characteristic determiner 84. Contextual characteristics may include the present time, location, activity, etc. of the user and/or the apparatus 50. Thus, for example, the contextual characteristic determiner 84 may interact with one or more sensors to determine that the user is presently at home, at work, or outside walking Information relating to the location of the user may, for example, be provided by a GPS module, though location information may additionally or alternatively be provided through other means such as triangulation using cell phone towers in some embodiments. Other sensors may include an accelerometer that may provide information from which the contextual characteristic determiner 84 may determine the activity of the user and/or the apparatus 50. The contextual characteristic determiner 84 may also determine the context in a variety of other manners including based on the interaction of the user terminal with other devices, the user interaction with the user terminal, etc.

Thus, the apparatus 50, such as the processor 70, may determine one or more contextual characteristics. The contextual characteristic determiner 84 may work in conjunction with the user preference module 80 to capture contextual characteristics relating to the user interactions. In this regard, for example, the contextual characteristic determiner 84 may determine contextual characteristics at the time of the user interactions. Thus, the context under which a user interaction occurs may be determined. Conversely, user interactions may be monitored by the user preference module 80 when the contextual characteristic determiner detects a specified occurrence. For example, the apparatus 50 may be configured such that when the user is at a certain latitude and longitude, as determined by the contextual characteristic determiner 84, the user preference module 80 may monitor one or more user interaction events with selectable segments of a content package. Accordingly, the apparatus 50 may be configured such that when the user is located at a particular location, the apparatus, such as the processor 70, may provide an external script within the content package with data so as to provide a dynamic content segment corresponding to both the contextual characteristics (e.g., the user's location) and the user preference model (e.g., the user's interest related to topics within the content package). In other embodiments, the apparatus 50, such as the processor 70, may be configured to receive additional content packages related to the dynamic content segment before the user selects the dynamic content segment. For instance, the apparatus 50, such as the processor 70, may be configured to receive additional content packages, such as data from a URL corresponding to a secondary content package related to the dynamic content segment such that the secondary content package may be presented to the user with minimal delay.

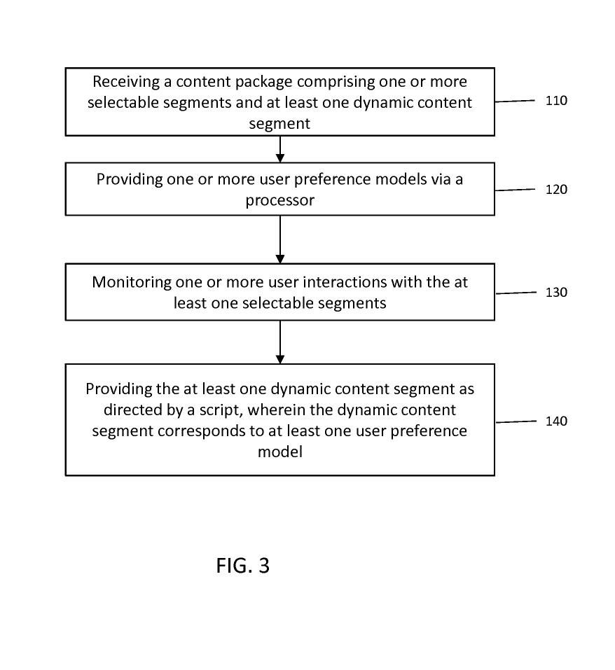

In terms of methods associated with embodiments of the present invention, the above-described apparatus 50 or other embodiments of apparatuses may be employed. In this regard, FIG. 3 is a flowchart of a system, method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by a computer program product including computer program instructions. In this regard, the computer program instructions which embody the procedures described above may be stored by a memory device and executed by a processor of an apparatus. As will be appreciated, any such computer program instructions may be loaded onto a computer or other programmable apparatus (for example, hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method may include receiving a content package comprising one or more selectable segments and at least one dynamic content segment at operation 110. In this regard, the apparatus 50 may include means, such as the communication interface 74, the processor 70 or the like, for receiving the content package. Further, the method may include providing one or more user preference models at operation 120. The apparatus 50 may therefore also include means, such as the memory device 76, the processor 70 or the like, for providing one or more user preference models. Additionally, the method may include monitoring one or more user interactions with the at least one selectable segments at operation 130 and providing the at least one dynamic content segment as directed by a script at operation 140. As such, the apparatus 50 may include means, such as the user preference module 80, the processor 70 or the like, for monitoring the user interactions and means, such as the processor 70, the user interface 72 or the like, for providing the dynamic content segment.

In some embodiments, certain operations may be further modified or additional operations may be included for providing a dynamic content package corresponding to topics provided within a segment of a content package. In one embodiment, the method may include receiving a content package comprising one or more selectable segments and determining topics provided therein, the topics relating to one or more segments of the content package. For example, the apparatus may be configured to load a web page displaying a list of news stories, which include hyperlinks to additional content describing the news story in more depth, the hyperlink directing the user to information located within the same domain as the original content package. Accordingly, in one embodiment, the method may include retrieving the topics related to each of the news stories. The apparatus 50 may therefore include means, such as the processor 70 or the like, for determining topics provided by the selectable segments of the content package and means, such as the processor 70, the memory device 76 or the like, for retrieving the topics related to each of the news stories.

Further, in another embodiment, the method may include comparing the retrieved topics to at least one user preference model such that the apparatus 50 may include means, such as the processor 70 or the like, for making the comparison. The user preference model may include data corresponding to a duration a user views a particular web page or content package, how often a user accesses a particular web page or content package, and/or other contextual characteristics relating to the user, such as the time of day when a user most frequently accesses a web page or content package. In one embodiment, the user preference model may further include data corresponding to the strength of the focus between a particular content segment of the content package and the user. In another embodiment, the user preference model may further include a prioritization of those web pages, content packages, and/or topics the user accesses, the prioritization being based at least in part on the duration of each access, the time of day the user accesses the content, how often a user accesses related content, and/or the like. As such, the method may include comparing the retrieved topics to the data defined by the user preference model.

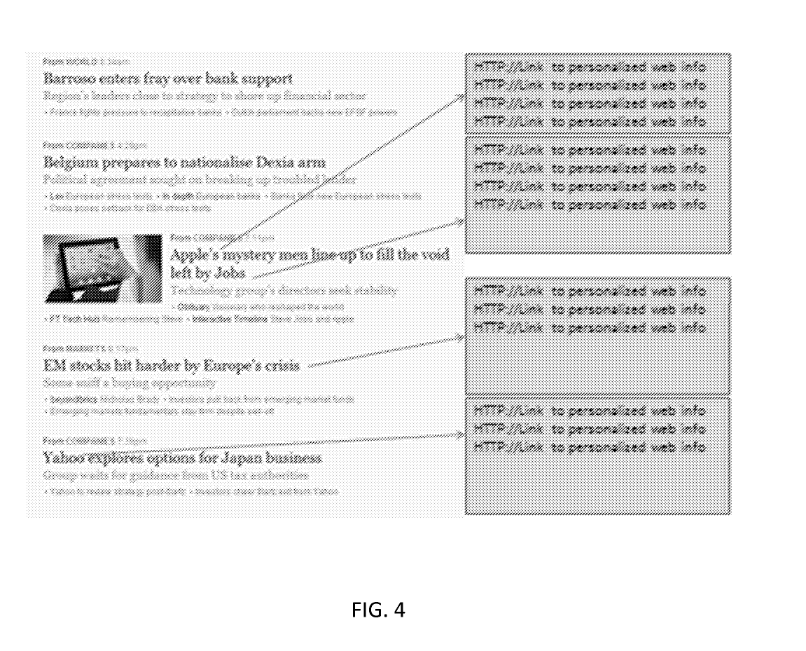

Further, the method may include prioritizing the retrieved topics based at least in part on the user preference model, wherein the user preference model includes data corresponding to a pre-defined prioritized listing of topics and/or content. As such, the apparatus 50 may include means, such as the processor 70 or the like, for prioritizing the retrieved topics. In addition or alternatively, the apparatus 50 may include means, such as the processor 70 or the like, for defining a set of topic categories for matching the topics of the content segments and/or a user's particular interest. In this regard, the apparatus may include means for defining a set of topics, such as “sports”, “finance”, “shopping” or the like, for matching the topics of the content segments and/or a particular user interest. In addition, the method may include providing data related to the matched and prioritized topics to the content provider such that a script may provide at least one dynamic content segment corresponding to the matched and prioritized topics. The script may be configured to provide the dynamic content segment in a number of manners, including providing hyperlinks to URLs on a user interface so that a user may quickly access the dynamic content, as shown in a user interface of an example embodiment illustrated in FIG. 4.

In addition, the method may include determining a contextual characteristic and comparing the contextual characteristic with the user preference model so as to provide a dynamic content segment corresponding to the contextual characteristic and the user preference model. In this regard, the apparatus 50 may include means, such as a processor 70 or the like, for determining a contextual characteristic and comparing the contextual characteristic with the user preference model. In one example, the apparatus 50 may be configured to determine that a user is located at a particular location, such as at a train station, and may be further configured to receive a dynamic content segment, such as news stories, when the user receives a content package. The user preference model may include data corresponding to the user's particular location, i.e., the train station, and the frequency and/or duration the user accesses content packages relating to news stories when the user is at the particular location. In another example embodiment, the user preference model may include data corresponding to the time of day, such as the weekend, such that the apparatus 50 may receive a content package with a dynamic content segment relating to shopping, coupons, or other commercial activities as the user preference model includes data indicating the user prefers to shop on the weekend.

With regard to the method including monitoring one or more user interactions with the at least one selectable segments of the content package at operation 120, the method may further include monitoring the location of user focus within the user interface, such as the mouse pointer or other cursor within the browser application displaying the content package. Additionally or alternatively, the method may include monitoring a user's eye movement so as to determine which particular content segment of the content package the user is focusing upon. Accordingly, the method may include receiving a dynamic content segment as directed by a script configured to display the dynamic content segment, the dynamic content segment corresponding to at least one of the user preference models, a user interaction, contextual characteristics, and/or the like, or any combination of the above. Accordingly, the dynamic content segment provided by the content package may change as a user shifts focus within the user interface. In another embodiment, a user may be provided with a content package such as document with fields configured to receive an input from the user. The method may include monitoring the user's focus such that when a user focuses on a particular field, the content package may provide a dynamic content segment such that the field to receive the user input is highlighted or otherwise distinguished from other content segments. Additionally, the apparatus, such as the processor, may be configured to interact with the dynamic content segment such that a mouse cursor or typing cursor is moved to the dynamic content segment.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and the computer program code configured to, with the processor, cause the apparatus to:
receive a content package comprising:
one or more selectable segments; and
at least one dynamic content segment;
provide for one or more user preference models;
monitor one or more user interactions with at least one of the selectable segments; and
provide the at least one dynamic content segment as directed by a script, wherein the dynamic content segment corresponds to at least one user preference model.

2. The apparatus of claim 1 further configured to determine one or more contextual characteristics corresponding to the user interaction.

3. The apparatus of claim 1, wherein the script is configured to provide at least one dynamic content segment, the dynamic content segment corresponding to a content segment defined by the user preference model.

4. The apparatus of claim 1, wherein the script is configured to provide at least one dynamic content segment, the dynamic content segment corresponding to at least one user-selected segment corresponding to the user interaction.

5. The apparatus of claim 1, wherein the script is further configured to prioritize the plurality of dynamic content segments based at least in part on one or more user preference models.

6. The apparatus of claim 1, wherein the script is further configured to prioritize the plurality of dynamic content segments based at least in part on the user interaction.

7. The apparatus of claim 1, further comprising user interface control circuitry configured to facilitate user control of at least some functions of the apparatus through the use of a display, and cause at least a portion of the a user interface of the apparatus to be displayed on the display to facilitate user control of at least some functions of the apparatus.

8. A method, comprising:
receiving a content package comprising one or more selectable segments and at least one dynamic content segment;
providing for one or more user preference models;
monitoring one or more user interactions with at least one of the selectable segments via a processor; and
providing the at least one dynamic content segment as directed by the script, wherein the dynamic content segment corresponds to at least one user preference model.

9. The method of claim 8 further comprising determining one or more contextual characteristics corresponding to the user interaction.

10. The method of claim 8, wherein the script is configured to provide at least one dynamic content segment, the dynamic content segment corresponding to a content segment defined by the user preference model.

11. The method of claim 8, wherein the script is configured to provide at least one dynamic content segment, the dynamic content segment corresponding to at least one user-selected segment corresponding to the user interaction.

12. The method of claim 1, wherein the script is further configured to prioritize the plurality of dynamic content segments based at least in part on one or more user preference models.

13. The method of claim 1, wherein the script is further configured to prioritize the plurality of dynamic content segments based at least in part on the user interaction.

14. The method of claim 1, wherein the script is further configured to modify the selectable segments of the content package based at least in part on one or more user preference models.

15. A computer program product comprising at least one non-transitory computer-readable storage medium having computer-readable program instructions stored therein, the computer-readable program instructions comprising program instructions configured to cause an apparatus to perform a method comprising:
receiving a content package comprising one or more selectable segments and at least one dynamic content segment;
providing for one or more user preference models;
monitoring one or more user interactions with at least one of the selectable segments; and
providing the at least one dynamic content segment as directed by the script, wherein the dynamic content segment corresponds to at least one user preference model.

16. The computer program product of claim 15 further configured to cause an apparatus to perform a method further comprising determining one or more contextual characteristics corresponding to the user interaction.

17. The computer program product of claim 15, wherein the script is configured to provide at least one dynamic content segment, the dynamic content segment corresponding to a content segment defined by the user preference model.

18. The computer program product of claim 15, wherein the script is configured to provide at least one dynamic content segment, the dynamic content segment corresponding to at least one user-selected segment corresponding to the user interaction.

19. The computer program product of claim 15, wherein the script is further configured to prioritize the plurality of dynamic content segments based at least in part on one or more user preference models.

20. The computer program product of claim 15, wherein the script is further configured to prioritize the plurality of dynamic content segments based at least in part on the user interaction.
